(19) United States
(12) Patent Application Publication
(10) Pub. No.: US 2026/0063089 A1
(43) Pub. Date: Mar. 5, 2026

(54) SYSTEM AND METHOD TO REDUCE VEHICLE NOx EMISSIONS

(71) Applicant: FCA US LLC, Auburn Hills, MI (US)

(72) Inventors: Boopathi S Mahadevan, Auburn Hills, MI (US); Tracy G Muchler, Auburn Hills, MI (US)

(21) Appl. No.: 18/819,324

(22) Filed: Aug. 29, 2024

(51) Int. Cl. F02D 41/30

(52) U.S. Cl. CPC F02D 41/30

(57) ABSTRACT

An engine control system includes one or more oxygen (O2) sensors disposed proximate to a three-way catalytic converter (TWC) in an exhaust system of the vehicle, a nitrogen oxides (NOx) sensor configured to measure an NOx level of the exhaust gas downstream of the TWC, and a controller. The controller is programmed to determine a downstream O2 sensor control error, compare the O2 sensor control error to a predetermined threshold voltage, enable an NOx control logic if the O2 sensor control error is less than the predetermined threshold voltage, monitor the NOx sensor and integrate a measured NOx concentration for a predetermined time threshold or NOx flow threshold, determine a lambda compensation based on the integrated NOx concentration, and adjust an air/fuel ratio of the engine based on the lambda compensation to reduce NOx breakthrough.

### FIELD

The present application relates generally to vehicle engine exhaust treatment systems and, more particularly, to exhaust treatment systems to reduce NOx emissions from ultra-low emissions gasoline vehicles.

### BACKGROUND

Catalysts are typically implemented in vehicle exhaust systems for treating exhaust gas produced by an internal combustion engine to mitigate or eliminate emissions. A three-way catalytic converter (TWC) is a specific type of catalyst that is typically implemented in exhaust systems of vehicles having stoichiometric burn engines. The TWC is configured to oxidize carbon monoxide (CO) and unburnt hydrocarbons (HC) to produce carbon dioxide (CO2) and water (H2O), as well as reduce nitrogen oxides (NOx) to nitrogen (N2). However, NOx control is difficult to achieve only using traditional oxygen sensor-based controls, which may result in NOx breakthrough. Known solutions include providing a large enough catalyst to tolerate NOx emissions due to oxygen sensor-based control logic, but this leads to higher cost aftertreatment systems. Thus, while such conventional systems work for their intended purpose, it is desirable to provide continuous improvement in the relevant art.

### SUMMARY

In accordance with one example aspect of the invention, a control system for an engine of a vehicle is provided. In one example implementation, the control system includes one or more oxygen (O2) sensors disposed proximate to a three-way catalytic converter (TWC) in an exhaust system of the vehicle, the one or more O2 sensors each being configured to measure an O2 level of exhaust gas produced by the engine, a nitrogen oxides (NOx) sensor configured to measure an NOx level of the exhaust gas downstream of the TWC, and a controller in signal communication with the one or more O2 sensors and the NOx sensor. The controller is programmed to determine a downstream O2 sensor control error, compare the O2 sensor control error to a predetermined threshold voltage, enable an NOx control logic if the O2 sensor control error is less than the predetermined threshold voltage, monitor the NOx sensor and integrate a measured NOx concentration for a predetermined time threshold or NOx flow threshold, determine a lambda compensation based on the integrated NOx concentration, and adjust an air/fuel ratio of the engine based on the lambda compensation to reduce NOx breakthrough.

In addition to the foregoing, the described control system may include one or more of the following features: wherein the at least one O2 sensor includes a first O2 sensor and a second O2 sensor; wherein the TWC includes a first catalyst disposed upstream of a second catalyst, and wherein the first O2 sensor is disposed upstream of the first catalyst, and the second O2 sensor is disposed downstream of the first catalyst and upstream of the second catalyst; and wherein the NOx sensor is disposed downstream of the second catalyst.

In addition to the foregoing, the described control system may include one or more of the following features: wherein the O2 control error is a downstream O2 sensor voltage subtracted by a calibrated setpoint voltage that provides optimum emissions conversion efficiency, and wherein the O2 control error is compensated in order to provide optimum NOx control; wherein the lambda compensation is calculated from a predetermined NOx gain table; and wherein the lambda compensation is added to an oxygen sensor-based proportional gains and integral gains from the one or more oxygen sensors, to thereby determine a net lambda compensation, and wherein the air/fuel ratio of the engine is adjusted based on the net lambda compensation to reduce NOx breakthrough.

In accordance with another example aspect of the invention, a method of reducing nitrogen oxides (NOx) in an exhaust aftertreatment system is provided. In one example, the aftertreatment system includes one or more oxygen (O2) sensors and an NOx sensor disposed proximate to a three-way catalytic converter (TWC), the one or more O2 sensors each being configured to measure an O2 level of exhaust gas produced by an engine, and the NOx sensor configured to measure an NOx level of the exhaust gas downstream of the TWC.

In one example implementation, the method includes determining, by a controller, a downstream O2 sensor control error; comparing, by the controller, the O2 sensor control error to a predetermined threshold voltage; enabling, by the controller, an NOx control logic if the O2 sensor control error is less than the predetermined threshold voltage; monitoring, by the controller, the NOx sensor and integrating a measured NOx concentration for a predetermined time threshold or NOx flow threshold; determining, by the controller, a lambda compensation based on the integrated NOx concentration; and adjusting, by the controller, an engine air/fuel ratio based on the lambda compensation to reduce NOx breakthrough.

In addition to the foregoing, the described method may include one or more of the following features: wherein the at least one O2 sensor includes a first O2 sensor and a second O2 sensor; wherein the TWC includes a first catalyst disposed upstream of a second catalyst, and wherein the first O2 sensor is disposed upstream of the first catalyst, and the second O2 sensor is disposed downstream of the first catalyst and upstream of the second catalyst; and wherein the NOx sensor is disposed downstream of the second catalyst.

In addition to the foregoing, the described method may include one or more of the following features: wherein the O2 control error is a downstream O2 sensor voltage subtracted by a calibrated setpoint voltage that provides optimum emissions conversion efficiency, and wherein the O2 control error is compensated in order to provide optimum NOx control; wherein the lambda compensation is calculated from a predetermined NOx gain table; and wherein the lambda compensation is added to an oxygen sensor-based proportional gains and integral gains from the one or more oxygen sensors, to thereby determine a net lambda compensation, and wherein the air/fuel ratio of the engine is adjusted based on the net lambda compensation to reduce NOx breakthrough.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings references therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a schematic diagram of an example vehicle having an internal combustion engine and an exhaust system in accordance with the principles of the present application;

FIG. 2 is a flow diagram of an example control method of reducing NOx emissions of the engine and exhaust system of FIG. 1, in accordance with the principles of the present application;

FIG. 3 illustrates an example plot of engine exhaust NOx concentration before lambda compensation, in accordance with the principles of the present application; and

FIG. 4 illustrates an example plot of engine exhaust NOx concentration after lambda compensation, in accordance with the principles of the present application.

### DESCRIPTION

As previously mentioned, some vehicle exhaust systems include a three-way catalytic converter (TWC) to convert exhaust gas constituents such as carbon monoxide (CO), carbon dioxide (CO2), oxygen (O2), hydrocarbons (HC), non-methane hydrocarbons (NMHC), and nitrogen oxides (NOx) to reduce emissions. The system typically includes engine out and mid-TWC O2 sensors for emissions controls. However, traditional O2 sensor-based emissions control makes it difficult to control NOx breakthrough emissions.

Accordingly, the systems and methods described herein are configured to improve NOx emissions, particularly in ultra-low emissions gasoline vehicles. In one example, the system includes an NOx sensor and associated control algorithm configured to determine additional O2 sensor integral gain based on the mid TWC NOx concentrations or post TWC NOx concentrations. The NOx sensor signal at the mid TWC or post TWC is continuously integrated only when the mid TWC O2 sensor control error is within a threshold (TH1) voltage. For example, the TH1 voltage may be around 20 mV, which is within a measurement resolution of the O2 sensor.

Once the O2 sensor error is within the TH1 voltage, the NOx control logic is enabled and calculates the integrated NOx sensor concentration or NOx flow for a predetermined time or target flow. The integral gain is calculated in the lambda domain and is applied to upstream lambda calculation to compensate for the NOx breakthrough in the exhaust. The NOx values are integrated (added) over a period of time and the integral gain is the calculated correction values in terms of lambda or air/fuel ratio. Using the lambda domain enables the calculated correction values to be added directly to a lambda value. As such, the lambda compensation is a correction to the air/fuel ratio, calculated based on the integrated NOx sensor errors, used to significantly reduce NOx emissions.

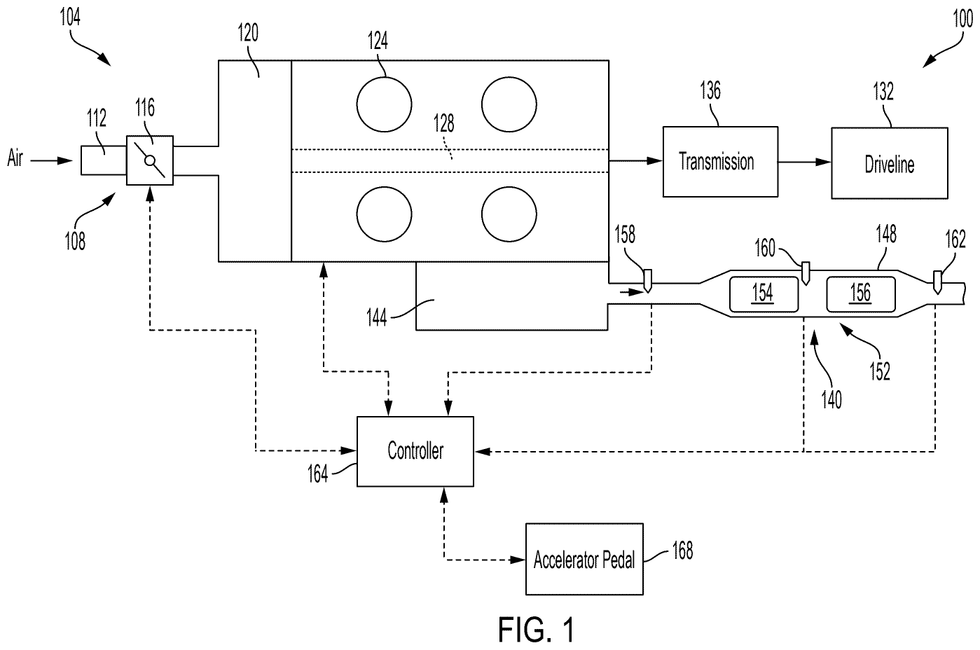

Referring now to FIG. 1, a diagram of an example vehicle 100 is illustrated. The vehicle 100 comprises a stoichiometric combustion engine 104 capable of operating with a rich fuel/air ratio. Non-limiting examples of a type of fuel that the engine 104 could utilize include gasoline, compressed natural gas (CNG), and liquefied natural gas (LNG). The engine 104 draws air through an induction system 108 comprising an induction passage 112, a throttle valve 116, and an intake manifold 120. The air in the intake manifold 120 is dispersed to cylinders 124 and combined with fuel to form a fuel/air mixture that is combusted (e.g., by spark plugs) within cylinders 124 to drive pistons (not shown) that rotatably turn a crankshaft 128 generating drive torque. While four cylinders are shown, it will be appreciated that the engine 104 could include any suitable number of cylinders (six, eight, etc.).

The drive torque is transferred to a driveline 132 via a transmission 136. It will be appreciated that the vehicle 100 could have a hybrid driveline where the drive torque generated by the engine 104 is transferred to an electric motor or generator instead of or in addition to the transmission 136. Exhaust gas resulting from combustion is expelled from the cylinders 124 into an exhaust system 140. The exhaust system 140 comprises an exhaust manifold 144, an exhaust passage 148, and a TWC 152 disposed along the exhaust passage 148 and configured to mitigate or eliminate CO, HC, NMHC, and NOx in the exhaust gas.

The TWC 152 includes an upstream brick or catalyst 154 and a downstream brick or catalyst 156 for catalytic reactions. As previously discussed, the TWC 152 oxidizes the CO and HC (i.e., combines them with O2) to produce carbon dioxide (CO2) and water (H2O), and the TWC 152 reduces the NOx to nitrogen (N2) and O2. The exhaust system 140 further comprises an upstream exhaust gas O2 sensor 158, a downstream exhaust gas O2 sensor 160, and an NOx sensor 162. In the example embodiment, O2 sensor 158 is disposed upstream of the first catalyst 154, and the second O2 sensor 160 is disposed “mid-brick” between the first and second catalysts 154, 156. The NOx sensor 162 is disposed mid-brick between the first and second catalysts 154, 156, downstream of the second catalyst 156, or in any other suitable location.

It will be appreciated that the techniques of the present disclosure could be achieved using only one of O2 sensors 158, 160 (e.g., to save costs). However, utilizing both of the sensors 158, 160 may increase the accuracy and/or robustness of the techniques. It will be appreciated that the O2 sensors 158, 160 could be linear-type O2 sensors, switching-type O2 sensors, or some combination thereof. Whereas a switching-type O2 sensor switches its output in response to rich and lean fuel/air (FA) ratio transitions, a linear-type O2 sensor could output a voltage indicative of the FA ratio and thus this voltage could be monitored to determine when it passes through a voltage level associated with stoichiometry.

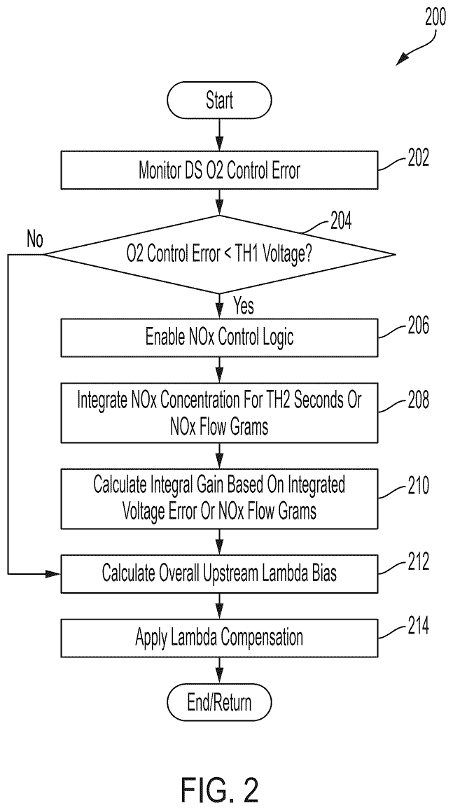

A control system or controller 164 (e.g., ECU) controls operation of the engine 104, such as controlling airflow/fueling/spark to achieve a desired drive torque. This desired drive torque could be based, for example, on input provided by a driver of the vehicle 100 via an accelerator pedal 168. The controller 164 controls the engine 104 to perform various fuel to air operations such as, for example, fuel enrichment events (rich fuel/air ratio operation, such as for increased power or exhaust gas cooling) and lean or fuel cutoff events (lean fuel/air ratio operation, such as no fuel being injected during pedal-off deceleration). The controller 164 also implements at least a portion of the techniques of the present disclosure, which are described in greater detail below with respect to FIG. 2.

Referring now to FIG. 2, a flow diagram of an example method 200 of reducing NOx emissions in an exhaust aftertreatment system is illustrated according to the principles of the present application. While the components of vehicle 100 and FIG. 1 are referenced for explanatory purposes, it will be appreciated that this method 200 could be applicable to any suitable vehicle. The method begins at 202 and controller 164 (“control”) monitors a downstream O2 control error. In the example embodiment, the O2 control error is a measured downstream O2 sensor 160 voltage (or lambda value) subtracted by a target downstream voltage (or lambda value). The target downstream voltages or lambda values or setpoints are the calibration points that provide optimum emissions conversion efficiency (e.g., for CO, HC, and NOx) identified on a test engine or vehicle. As there may be vehicle-to-vehicle variations associated with small variations in the components, there may be errors in the oxygen sensor control. These errors must be compensated in order to provide optimum NOx control.

At 204, control determines if the O2 control error is less than a first predetermined threshold (TH1) voltage. In this step, the O2 control error is compared with the TH1 threshold voltage (or lambda value). In one example, with both oxygen sensor and NOx sensor-based control, there is a separation of control authority between O2 sensor-based control and NOx sensor-based control, because both controls are adjusting the air/fuel ratio of the engine as their final control output. The air/fuel ratio corrections based on the O2 sensors are similar to a coarse controller that should be applied first, and the NOx sensor-based corrections to the air/fuel ratio is a fine control that is defined via threshold TH1. The threshold TH1 determines the correct O2 sensor error level to then activate NOx sensor-based control.

As such, if the O2 control error is not less than threshold TH1, control proceeds to step 212. If yes, control proceeds to step 206 and enables the control logic for the NOx based compensation to determine correction to the air/fuel signals based on the integrated NOx sensor values. At 208, control monitors the NOx sensor 162 and integrates the measured NOx concentration for a predetermined threshold time period or predetermined threshold NOx flow (e.g., in grams) (TH2). Accordingly, the NOx concentrations measured from NOx sensor 162 are integrated over a period of time as long as the conditions are below threshold TH2. If there is continued output of NOx from the exhaust gas, the integrated value increases, which thereby increases the magnitude of the air/fuel ratio correction.

At 210, control calculates integral gain based on integrated voltage error or NOx flow (e.g., in grams). In other words, control determines the magnitude of the air/fuel ratio correction that needs to be applied to reduce NOx emissions. In this step, the calculated gain value from an NOx gain table (see Table 1 below) is added with other oxygen sensor-based gains such a proportional and integral gains from the downstream oxygen sensor 160. These values are added to calculate the net oxygen sensor compensation, also referred to as lambda compensation, which is a correction to the air/fuel ratio setpoint of the controller 164.

TABLE 1

| | | | | |
|---|---|---|---|---|
| Integrated NOx | −0.01 | −0.005 | 0.005 | 0.01 |
| value (g) or NOx | | | | |
| Flow (g/s) | | | | |
| Gain (air/fuel | −0.15 | 0 | 0 | 0.15 |
| ratio correction) | | | | |

In the example Table 1, the first row is the measured NOx error in NOx Flow (g/s) or NOx (g). This is the integrated NOx values over the predetermined period of time. The second row indicates the magnitude of the air/fuel ratio correction that needs to be applied to minimize NOx from the exhaust. For example, if the NOx values are 0.1 g/s or 0.1 gram, the air/fuel ratio correction (gain) of 0.15 is selected.

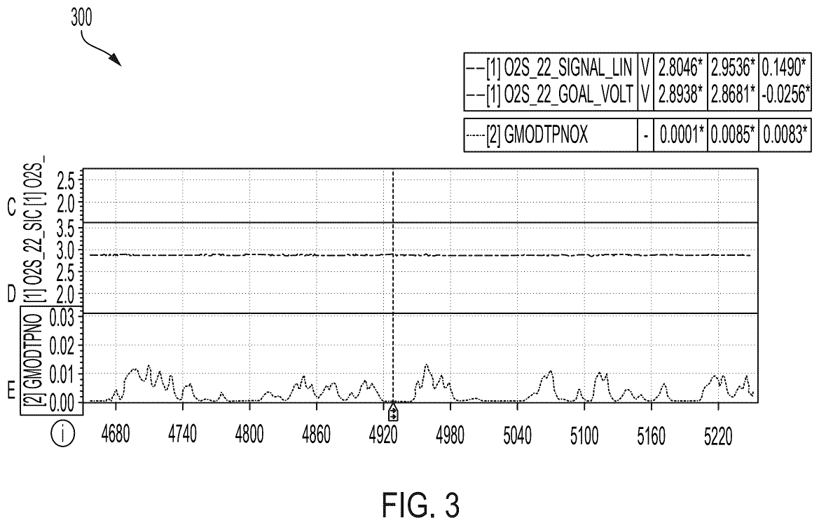

For example, as shown in FIG. 3, there will be a downstream NOx integral gain of 0.15 (where positive gain values mean the system will move towards rich side to compensate for a lean system) for an NOx error of 0.01 g/s or 0.01 g. FIG. 3 illustrates an example plot 300 of NOx concentration before lambda compensation.

Control then proceeds to step 212 and calculates an overall upstream lambda bias as the sum of the downstream O2 proportional gain lambda, the downstream O2 integral gain lambda, and the downstream NOx integral gain. In one example, overall upstream lambda bias is the air/fuel ratio correction calculated based on the measure O2 values from the upstream O2 sensor 158. The downstream O2 proportional gain lambda is the air/fuel ratio correction calculated based on the downstream O2 sensor error. The downstream O2 integral gain lambda is the air/fuel ratio correction calculated based on the downstream O2 sensor error. The downstream NOx integral gain is the air/fuel ratio correction calculated based on the downstream NOx, for example, using Table 1. The proportional gain is the air/fuel corrections applied based on the instantaneous error in the system (measured vs. actual). The integral gain is the air/fuel correction applied based on the accumulated error over a period of time.

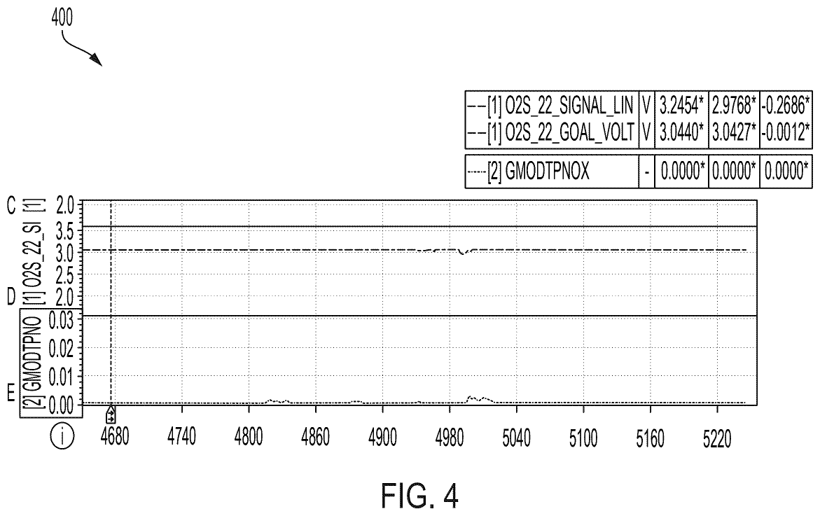

At step 214, control then applies the lambda compensation by adjusting the air/fuel ratio command to the engine, based on the magnitude of error, to thereby reduce NOx emissions. FIG. 4 is an example plot 400 of NOx breakthrough after the lambda compensation is applied, as compared to the NOx breakthrough seen in FIG. 3.

It will be appreciated that the term “controller” or “module” as used herein refers to any suitable control device or set of multiple control devices that is/are configured to perform at least a portion of the techniques of the present disclosure. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present disclosure. The one or more processors could be either a single processor or two or more processors operating in a parallel or distributed architecture.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present disclosure, its application or uses. Thus, variations that do not depart from the gist of the present disclosure are intended to be within the scope of the present disclosure.

1. A control system for an engine of a vehicle, the control system comprising:
one or more oxygen (O2) sensors disposed proximate to a three-way catalytic converter (TWC) in an exhaust system of the vehicle, the one or more O2 sensors each being configured to measure an O2 level of exhaust gas produced by the engine;
a nitrogen oxides (NOx) sensor configured to measure an NOx level of the exhaust gas downstream of the TWC; and
a controller in signal communication with the one or more O2 sensors and the NOx sensor, the controller programmed to:
determine a downstream O2 sensor control error;
compare the O2 sensor control error to a predetermined threshold voltage;
enable an NOx control logic if the O2 sensor control error is less than the predetermined threshold voltage;
monitor the NOx sensor and integrate a measured NOx concentration for a predetermined time threshold or NOx flow threshold;
determine a lambda compensation based on the integrated NOx concentration; and
adjust an air/fuel ratio of the engine based on the lambda compensation to reduce NOx breakthrough.

2. The control system of claim 1, wherein the at least one O2 sensor includes a first O2 sensor and a second O2 sensor.

3. The control system of claim 2, wherein the TWC includes a first catalyst disposed upstream of a second catalyst, and
wherein the first O2 sensor is disposed upstream of the first catalyst, and the second O2 sensor is disposed downstream of the first catalyst and upstream of the second catalyst.

4. The control system of claim 3, wherein the NOx sensor is disposed downstream of the second catalyst.

5. The control system of claim 1, wherein the O2 control error is a downstream O2 sensor voltage subtracted by a calibrated setpoint voltage that provides optimum emissions conversion efficiency, and
wherein the O2 control error is compensated in order to provide optimum NOx control.

6. The control system of claim 1, wherein the lambda compensation is calculated from a predetermined NOx gain table.

7. The control system of claim 6, wherein the lambda compensation is added to an oxygen sensor-based proportional gains and integral gains from the one or more oxygen sensors, to thereby determine a net lambda compensation, and
wherein the air/fuel ratio of the engine is adjusted based on the net lambda compensation to reduce NOx breakthrough.

8. A method of reducing nitrogen oxides (NOx) in an exhaust aftertreatment system having one or more oxygen (O2) sensors and an NOx sensor disposed proximate to a three-way catalytic converter (TWC), the one or more O2 sensors each being configured to measure an O2 level of exhaust gas produced by an engine, and the NOx sensor configured to measure an NOx level of the exhaust gas downstream of the TWC, the method comprising:
determining, by a controller, a downstream O2 sensor control error;
comparing, by the controller, the O2 sensor control error to a predetermined threshold voltage;
enabling, by the controller, an NOx control logic if the O2 sensor control error is less than the predetermined threshold voltage;
monitoring, by the controller, the NOx sensor and integrating a measured NOx concentration for a predetermined time threshold or NOx flow threshold;
determining, by the controller, a lambda compensation based on the integrated NOx concentration; and
adjusting, by the controller, an engine air/fuel ratio based on the lambda compensation to reduce NOx breakthrough.

9. The method of claim 8, wherein the at least one O2 sensor includes a first O2 sensor and a second O2 sensor.

10. The method of claim 9, wherein the TWC includes a first catalyst disposed upstream of a second catalyst, and
wherein the first O2 sensor is disposed upstream of the first catalyst, and the second O2 sensor is disposed downstream of the first catalyst and upstream of the second catalyst.

11. The method of claim 10, wherein the NOx sensor is disposed downstream of the second catalyst.

12. The method of claim 8, wherein the O2 control error is a downstream O2 sensor voltage subtracted by a calibrated setpoint voltage that provides optimum emissions conversion efficiency, and
wherein the O2 control error is compensated in order to provide optimum NOx control.

13. The method of claim 8, wherein the lambda compensation is calculated from a predetermined NOx gain table.

14. The method of claim 13, wherein the lambda compensation is added to an oxygen sensor-based proportional gains and integral gains from the one or more oxygen sensors, to thereby determine a net lambda compensation, and
wherein the air/fuel ratio of the engine is adjusted based on the net lambda compensation to reduce NOx breakthrough.
